(19) United States
(12) Patent Application Publication
(10) Pub. No.: US 2026/0352849 A1
(43) Pub. Date: Nov. 5, 2026

(54) ENCODING AND DECODING BRANCHING VIDEO SEQUENCES

(71) Applicant: Playcast, Inc., Seattle, WA (US)

(72) Inventors: Aaron Lewis Overton, Blountville, TN (US); Alexander Kingsley St. John, Arlington, WA (US)

(21) Appl. No.: 19/327,844

(22) Filed: Sep. 12, 2025

Related U.S. Application Data
(60) Provisional application No. 63/800,205, filed on May 5, 2025.

(51) Int. Cl. H04N 19/172; A63F 13/52; H04N 19/162; H04N 19/70

(52) U.S. Cl. CPC H04N 19/172; A63F 13/52; H04N 19/162; H04N 19/70

(57) ABSTRACT

A branching media sequence data structure representing a branching media sequence is described. The data structure includes first information comprising representations of a plurality of candidate media segments that have been collectively compressed. The data structure also includes second information comprising branching logic specifying conditions whose evaluation by a playing device is configured to determine which of the candidate media segments are decompressed from the first information and rendered by the playing device at a particular point in time as part of rendering branching media sequence.

### CROSS-REFERENCE TO RELATED APPLICATION(S)

This application claims the benefit and priority to U.S. Application No. 63/800,205, entitled “ENCODING AND DECODING BRANCHING VIDEO SEQUENCES,” filed May 5, 2025, the entirety of which is hereby incorporated by reference.

In cases where a document incorporated by reference conflicts with the present application, the present application controls.

### BACKGROUND

Video compression involves transforming a linear sequence of video frames—and sometimes accompanying audio—into a representation that is efficient to store or transmit. This efficient representation is delivered to a video playing device, such as by physically carrying a Blu Ray disk to the playing device, or by electronically delivering it over the Internet. At the playing device, the efficient representation is decoded into a sequence of video frames and accompanying audio corresponding to the original sequence for playing by the video playing device.

In various cases, the playing device can be a physical media player, such as a Blu Ray or DVD player; a digital video recorder or set-top box; a media streaming device; a gaming console; a smart television; a PC, laptop, tablet, or other computer; XR goggles; etc., in some cases via a browser.

### BRIEF DESCRIPTION OF THE DRAWINGS

FIG. 1 is a block diagram showing some of the components typically incorporated in at least some of the computer systems and other devices on which the facility operates.

FIG. 2 is a network diagram showing an arrangement of devices in which the facility operates in some embodiments.

FIG. 3 is a data flow diagram depicting operation of the facility in some embodiments.

FIG. 4 is a flow diagram showing a process performed by the facility in some embodiments to generate an encoded video sequence.

FIG. 5 is a data structure diagram depicting a branching video sequence definition.

FIG. 6 is a table diagram showing sample contents of a branching table received by the facility in some embodiments to establish the sample branching logic shown in FIG. 5.

FIGS. 7 and 8 are media rendering diagrams showing examples of opportunities for compression efficacy taken advantage of by the facility in some embodiments.

FIG. 9 is a flow diagram showing a process performed by the facility in some embodiments to decode a branching video sequence.

### DETAILED DESCRIPTION

The inventors have recognized that the monolithically linear nature of conventional compressed or otherwise encoded video sequences limits their flexibility and usefulness.

In response, the inventors have conceived and reduced to practice a software and/or hardware facility for encoding and decoding branching video sequences (“the facility”). These branching video sequences are defined such that one or more conditional branches among video segments making up the video sequence provide different paths through the video sequence. In decoding the video sequence on a playing device, a decoder provided by the facility navigates the branches of the video sequence based on data such as an attribute of or state of the playing device, or input received by the playing device. Herein, these branching video sequences and video segments are variously referred to as audio/video sequences and segments, and media sequences and segments. In some embodiments, the facility encodes branching sequences in a way that is compliant with one or more branding-unaware video standards and formats.

For example, in various embodiments, a branch's condition may be: an ambient light level detected by the playing device, leading to segments each optimized for different ranges of ambient light level; for a game, a game action taken by a player by providing input to the playing device, leading to segments showing different events each responsive to a different game action; for an exploration of a physical environment, a path taken through the physical environment, leading to segments each showing the corresponding path; for a conversation with an artificial intelligence character, a response by a human participant to a statement or question by the character, leading to different segments in which the character further responds to different utterances by the human participant; etc.

In some embodiments, an encoder of the facility executing on a server receives a branching directory that specifies, for each of one or more branches: a condition to be evaluated at the branch; for each of a different range of values of the condition, an indication of a media segment that this range of values leads to; and optionally an indication of a subsequent branch that follows the indicated media segment. For example, in the context of a game in which a player's character is presently running toward a barrel, the branching directory may establish a first branch whose condition is whether the player gives input corresponding to a jumping game action; the branching directory indicates a first media segment in which the character travels upward and over the barrel for the case in which the player does give such input, and indicates a second media segment in which the character collides with the barrel for the case in which the player does not. Each media segment may be from a pre-existing library, or may be generated dynamically in connection with producing the branching directory, such as by a game engine or a separate Al frame extrapolator. This approach is described in greater detail in U.S. Patent Application No. 63/800,113, entitled “IMPROVING THE PERFORMANCE OF REMOTE GAMES AND REMOTE APPLICATIONS OF OTHER TYPES BY PREDELIVERING FUTURE OUTPUTS RESPONSIVE TO PREDICTED INPUTS,” filed on May 5, 2025; and U.S. patent application Ser. No. 19/327,601, entitled “IMPROVING THE LATENCY OF REMOTE GAMES IN REMOTE APPLICATIONS OF OTHER TYPES BY PREDELIVERING FUTURE OUTPUTS RESPONSIVE TO PREDICTIVE INPUTS,” filed on Sep. 12, 2025, each of which is hereby incorporated by reference in its entirety). In cases where a document incorporated by reference conflicts with the present application, the present application controls.

In response to receiving the branching directory, the encoder accesses the indicated media segments and collectively compresses or otherwise encodes them, in such a way that (1) each can be individually decoded based upon an identifier, and (2) conserves space that would otherwise be consumed by portions of the different segments that are redundant. As examples of redundancy, two or more segments may have one or more identical frames, and/or audio tracks that are the same or share constituent elements. Between multiple segments, certain frame subregions may have the same contents, such as a subregion in the center of the frames between two segments that correspond to different rotational orientations of the same video, or between two segments that pursue two paths through the same physical environment, such that the left side of the right-hand path visually corresponds to the right side of the left-hand path. Multiple segments can also be based on the same keyframe.

In another example, a player in a game is standing still. Because game characters are often programmed with a delayed response to input to simulate inertia, in some cases it is safe to assume that a handful of frames immediately following an input event in a programmed inertia game remain the same as the previous frames when the player was standing still. A 3D game will seldom have much video duplication because of dynamic lighting and extreme character customization common to modern games, but motion will be highly predictable, enabling highly-successful prediction to be achieved with a relatively small number of branches.

The facility causes the encoded result to be delivered to the playing device together with the branching directory, such as in a single video file or video stream, such as by including the branching directory in metadata for the encoded sequence. In various embodiments, the delivery is via a one-way or two-way network connection, or physical media such as a Blu-ray disk or flash storage vice. On the playing device, the facility reads the branching directory, and accesses the local branching data evaluated in the conditions specified for branches by the branching directory. The facility chooses a segment based upon the local branching data, decodes it, and causes it to be rendered. If the branching directory specifies another branch at the end of the rendered segment, the facility navigates this next branch in the same way. In some embodiments, the facility notifies the server of how each branch is navigated, enabling the server to design, construct, and deliver a subsequent branching video sequence that coherently follows the path navigated through the present branching video sequence. In some embodiments, the server has another, pre-existing information flow from the playing device that keeps it synchronized to the correct state, such as a stream of player input actions for a game.

By operating in some or all of the ways described above, the facility provides a good video playing experience that dynamically adjusts to various needs, preferences, and actions of its viewer, in a way that overcomes latency that would be experienced if similar branching was managed at the server rather than the playing device. The facility addresses the fundamental latency challenge in remote gaming: with typical network latencies of 100 ms and frame rates of 60 fps, approximately six frames of lag exist between user input and server response, assuming minimal processing latency by the server,. By encoding and transmitting these six potential future frames in advance, the facility enables the client to immediately display the correct frame when input occurs, providing a user experience as good as local gameplay.

The facility leverages several observations by the inventors about user input patterns: (1) Human reaction time and motor control abilities limit the possible frequency at which they can provide input; the most proficient human users can perform 15 deliberate actions per second as a maximum; because this frequency is so much lower than a typical frame rate, user input actions must necessarily affect a minority of frames. (2) Many inputs are continuous and predictable-mouse movements follow trajectories, in some cases corresponding to optical flow predictions; game pad thumbsticks have momentum; and character movement is often programmed to reflect inertia by delaying response to a player action by e.g., 3-4 frames. (3) Console controllers have finite inputs-such as six primary buttons plus two triggers and two analog sticks-and therefore a limited combination of actions that can be performed together. The facility is able to use compression as an approach to prediction, based upon the recognition that user input streams can compress up to 95%, corresponding to 95% predictability; similar frames compress efficiently together, and motion vectors enable frame extrapolation.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, less powerful versions of the following devices can be used, and/or a greater number of users can be effectively supported using existing devices: servers; networking links or networks; network switches, repeaters, or other hardware. Servers can be located at a greater geographic and/or network distance from playing devices, allowing them to be shared over larger groups of playing devices, larger ranges of time zones, etc., allowing them to consistently maintain higher utilization levels and provide greater value.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, the computations performed by the facility to encode and decode media streams are far too involved, extensive, and time-sensitive to practically be performed in the human mind. Relying on a human mind to perform these actions would prevent the facility from providing an adequate playing experience for the branching video sequences.

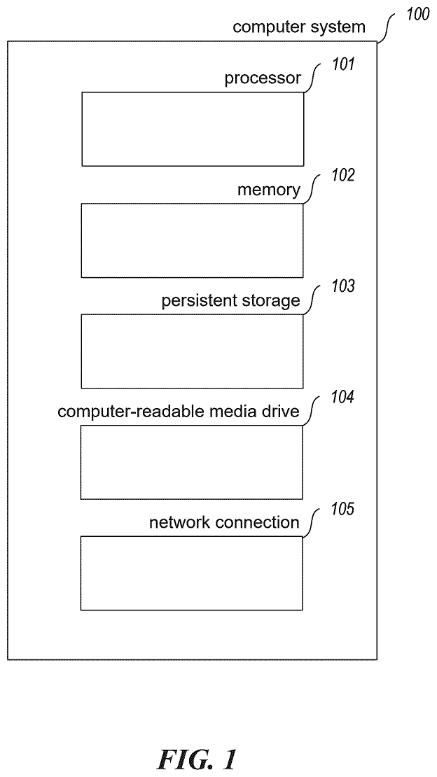

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 or discussed above constitute a data signal per se. While computer systems configured as described above are typically used to support the operation of the facility, those skilled in the art will appreciate that the facility may be implemented using devices of various types and configurations, and having various components.

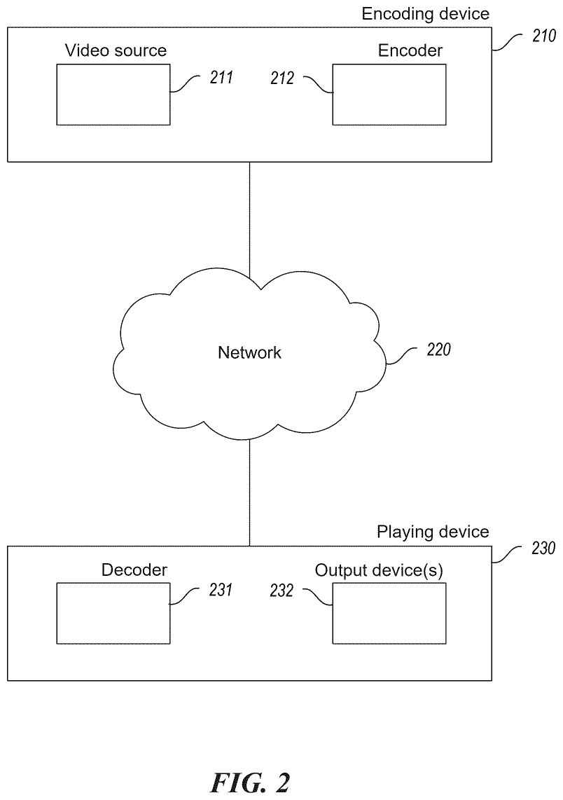

FIG. 2 is a network diagram showing an arrangement of devices in which the facility operates in some embodiments. An encoding device 210, such as a server, includes a video source 211, such as a library of existing video segments, or an engine for dynamically generating new video or other media segments, such as a game engine. In various embodiments, these segments can be two-dimensional video; two-dimensional video plus audio; three-dimensional video; three-dimensional video plus audio; two-dimensional binocular video; two-dimensional binocular video plus audio; etc. The encoding device also includes an encoder 212 for generating branching video sequences that include video segments from the video source. The encoder may have hardware and/or software elements. The encoding device is connected via a network 220 such as the Internet to a playing device on which video sequences produced by the encoding device can be rendered. In various embodiments, the playing device is a player for physical media, such as Blu-Ray discs or DVDs; a digital video recorder or set-top box; a media streaming device; a gaming console; a smart television; a PC, laptop, tablet, or other computer; VR, AR, or other XR goggles, headsets, glasses, image projectors, etc. The playing device includes a decoder 231 for, in a particular video sequence, determining a route through the branches of the video sequence, and decoding the segments of the video sequence that are a part of the determined route. In some embodiments, the decoder executes inside of or on behalf of a browser. The decoder may have hardware and/or software elements. In some embodiments, the facility implements its decoder 231 as a wrapper around a conventional video decoder that receives frames at a higher rate than the conventional decoder will use. For example, the facility may transmit the branching video sequence at a frame rate of 360 frames per second, which may provide six possible versions of a single frame plus a corresponding decision tree that the decoder uses to select the best version of this frame to pass to the conventional decoder for decoding and rendering on a playing device that is otherwise unmodified, dropping the remaining 5 versions of the frame without decoding them, and resulting in a display at 60 frames per second. The playing device also includes output devices 232 on which the playing device renders the decoded segments.

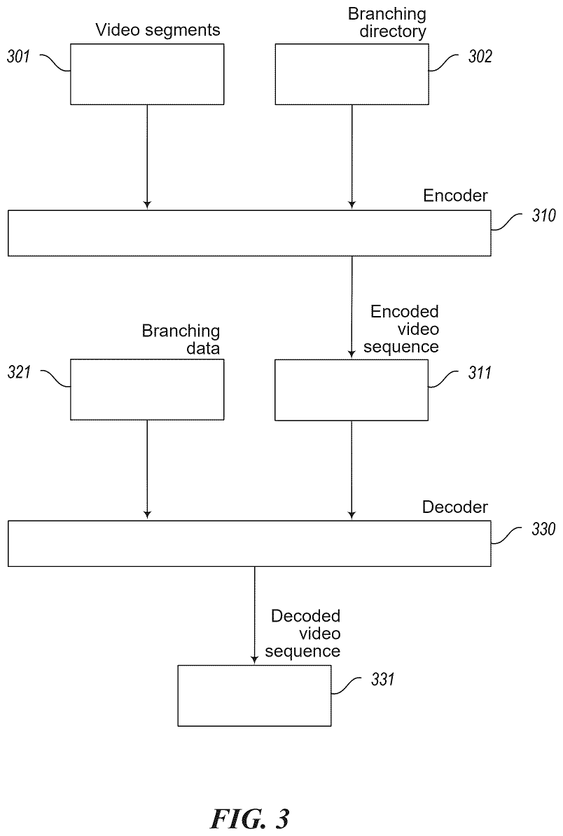

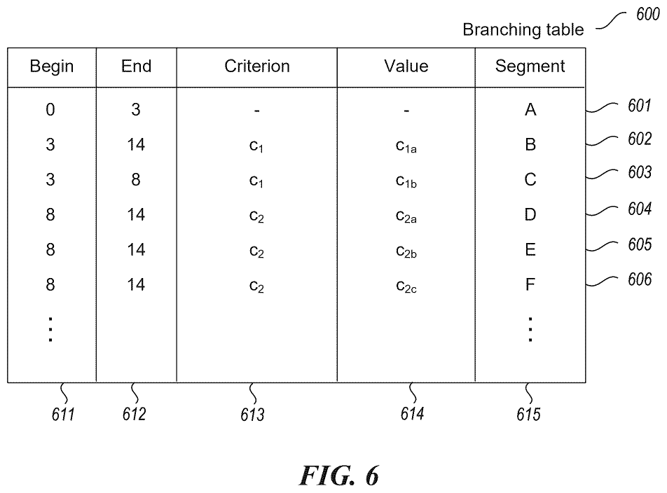

FIG. 3 is a data flow diagram depicting operation of the facility in some embodiments. The encoder 310 receives a definition for a branching video sequence to be encoded, such as the branching directory 302. In some embodiments, the branching directory is a branching table as depicted in FIG. 6 and described below. The sequence definition includes branching logic referring to the video segments that are available for rendering on the basis of the evaluation of these branches. The video segments 301 are also available to the encoder. The encoder produces an encoded video sequence 311 containing a version of the branching logic, as well as the video segments referenced in the branching logic. In some embodiments, the encoded video sequence is compressed by the encoder to reduce the overall size of the encoded video sequence with respect to aspects of included video segments that are the same or sufficiently similar. The decoder 330 receives the encoded video sequence, and applies the branching logic of the encoded video sequence to branching data 321 available to the decoder. In various embodiments, the branching data includes data such as a persistent attribute of the playing device or its user; a current transient state of the playing device; and/or input received by the playing device, such as via a game controller, keyboard, pointing device, camera, motion sensor, radar transceiver, microphone, etc. The decoder determines, based upon an evaluation of the branches of the branching logic with respect to the branching data, which segments of the video sequence should be rendered. It decodes these segments, in some embodiments to the exclusion of the other segments of the video sequence, to produce decoded video 331 that can be rendered by the playing device.

In some embodiments, rather than containing all of the frames for a predictive video segment, the facility includes one or more key frames, as well as optical flow vector fields useable to construct a series of one or more frames subsequent to each key frame.

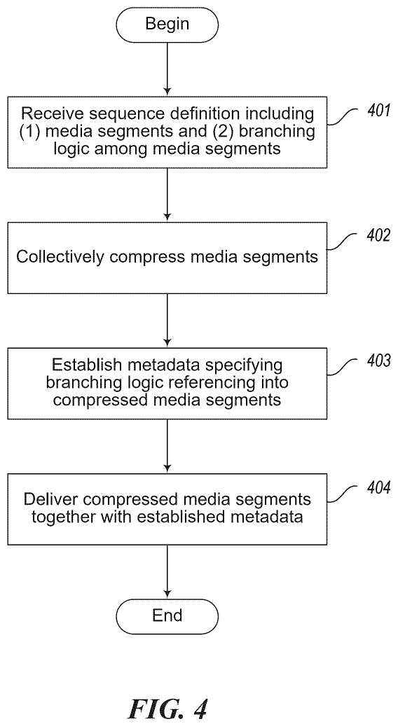

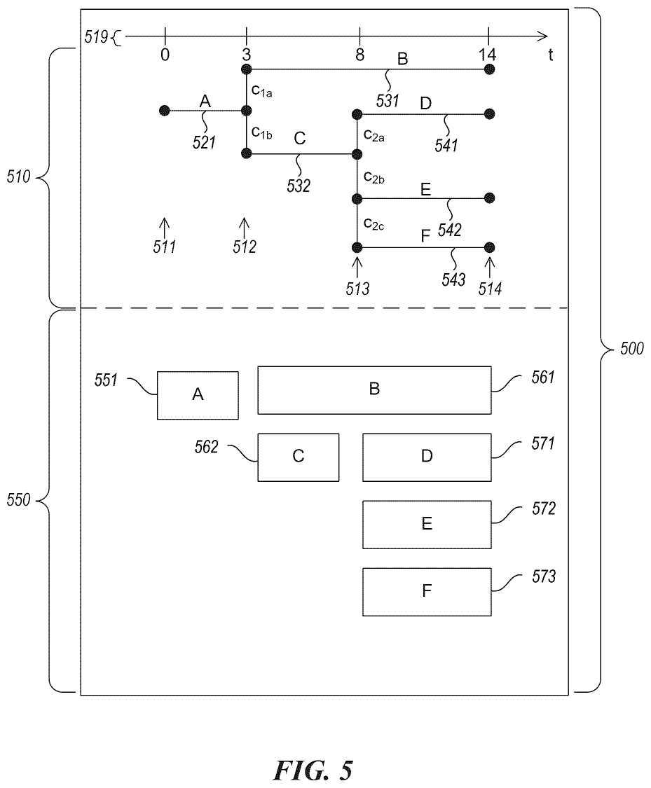

FIG. 4 is a flow diagram showing a process performed by the facility in some embodiments to generate an encoded video sequence. In act 401, the facility receives a definition for a branching video sequence that includes multiple media segments, and branching logic for navigating among these media segments. Details of these definitions are discussed below in connection with FIGS. 5 and 6. In act 402, the facility compresses the media segments together in a single blob. In some embodiments, the compression can exploit significant levels of similarity in certain groups of frames, such as a group of frames in which a character is still, and then beginning to move or has moved to only a limited degree. In some cases, across alternative branches there are small variations in timing, shared background elements, and common audio tracks that enable effective compression. In some embodiments, for branching conditions involving continuous input from input devices such as mice and thumbsticks, the facility stores key frames with motion vector fields showing changes from the key frames and subsequent frames; generates intermediate frames using hardware video decoders; predicts trajectories based on input momentum; and/or synthesizes frames without explicitly storing them. In some embodiments, the facility wraps standard video codecs, such as H.264, H265, and AV1 to also store branching metadata and a container format for the frames of alternative branches; frames at higher frames per second encoding, such as 360 frame per second, frame selection logic and backward compatibility with standard players. In some embodiments, the facility encodes alternative streams side-by-side in a higher resolution video and then selects to view only the subdomain of the video stream containing the chosen video branch.

In act 403, the facility establishes metadata for the video sequence specifying the branching logic, and referencing the individual media segments within the compressed blob in a way that permits them to be individually decompressed. In act 404, the facility assembles the metadata with the compressed blob into a media file, and delivers it to the playing device. In some embodiments, the facility wraps the output of a standard video encoder in a new format that includes the branching data plus metadata such as the input stream; a pre-decoder unpacks that specialized format and converts it to a normal encoded stream to feed to a player for standard decode and play operation. In various embodiments, the facility isolates the metadata in a header of the media file, or distributes the metadata such that metadata representing each branch occurs at the conclusion of the media segment's rendering directly preceding the branch in the branch and logic flow. After act 404, this process concludes.

Those skilled in the art will appreciate that the acts shown in FIG. 4 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 5 is a data structure diagram depicting a branching video sequence definition. The definition 500 has two portions: a set of media segments 550, and branching logic 510 for navigating among those media segments. The media segments are segment A 551, segment B 561, segment C 562, segment D 571, segment E 572, and segment F 573. The branching logic is shown relative to a timeline 519, in this case demarcated in units that are seconds. The branching logic shows that the sequence will begin with segment A rendered during a period 521 from time 511 (i.e., 0 seconds) to time 512 (i.e., 3 seconds). At time 512 (the conclusion of segment A's rendering), a two-way branch occurs: the existence of condition c₁ₐ causes segment B to be rendered for time period 531, from time 512 to time 514. On the other hand, condition c_{1b} causes segment C to be rendered for time period 532, from time 512 to time 513. A second, three-way branch occurs at time 513 at the end of rendering segment C: at this time, condition c₂ₐ causes the rendering of segment D during time period 541, from time 513 to time 514; condition c_{2b} causes the rendering of segment E during time period 542, from time 513 to time 514; and condition c_{2c} causes the rendering of segment F during time period 543, from time 513 to 514. As an example of rendering the sample branching media sequence depicted in FIG. 5: The rendering begins with segment A. At the end of segment A, at time 3, the facility tests a first condition c₁, and finds that it has the value c_{1b}. Accordingly, the facility next renders segment C, from time 3 to time 8. At time 8, the facility tests a second condition c₂, and determines it has the value c₂ₐ. Accordingly, the facility renders segment D, from time 8 to time 14.

In some embodiments, the facility assesses the probability of each branch being traversed using information including historical user behavior, current game state, and input momentum or trajectory. As an example relating to a game in which a character is approaching a barrel, the facility may generate a sample branching video sequence as follows: the sequence includes a branch point at which the player may jump or collide, which will occur if no action is taken within 100 ms. The player may also make a number of different, less likely actions at the same point. The facility attributes a 60% probability that no input will be provided within 100 ms; a 35% probability that the jump input action will be taken during this time; and a 5% likelihood that any other input will occur during this time. The resulting branching video sequence may have just two branches, one for the most highly likely outcome collision, and a second for the next-most-likely outcome jump. As a result, the branching video sequence contains a first segment in which the character approaches a barrel; and a branch between a second segment in which a collision occurs, and a third segment in which a jump occurs.

In some embodiments, the facility includes a mechanism for learning these probabilities in an accurate way. In some embodiments, the facility uses these probabilities at encoding time to limit the complexity of the branching logic and/or the total size of the media segments. In some embodiments (not shown), the facility labels the conditions with an estimate of the likelihood of their occurrence. In some embodiments, the facility uses this information to discard media segments from the set of media segments that have the smallest likelihood of being used in order to respond gracefully as possible to network capacity limitations, and/or limits on cache size.

In various embodiments, the facility makes available various techniques for specifying this branching logic, including using a visual user interface to assemble the segments and conditions; creating the branching logic in an appropriate textual tag language; creating a table or spreadsheet that indicates, for each of the segments, the time at which it will conditionally begin and end, and the criterion and value of that condition that will cause it to be rendered for that time period; etc. In some cases, the table described above is called a branching table.

FIG. 6 is a table diagram showing sample contents of a branching table received by the facility in some embodiments to establish the sample branching logic shown in FIG. 5. The branching table 600 is made up of rows each corresponding to a different segment included in the branching video sequence, such as rows 601-606. Each row is divided into the following columns: a beginning time column 611 indicating a time relative to the beginning of the sequence at which the segment will conditionally begin being rendered; an ending time column 612 containing a later time relative to the beginning of the sequence at which the segment, if rendered, will conclude being rendered; a criterion column 613 identifying a piece of branching data that will be used as a basis for determining whether the segment's condition is satisfied and the segment will be rendered during the designated time range; a value column 614 indicating a value or range of values of the criterion that will satisfy the condition and cause the segment to be rendered; and a segment identifier column 615 containing information identifying the segment, such as the name, unique identifier, pointer, etc. For example, row 602 indicates that segment B will be rendered at time 3, when the rendering of segment A ends, if the value of criterion c₁ is then c₁ₐ. In some embodiments (not shown), the facility orders the rows of the table all corresponding to a particular period in decreasing order of the probability that they will be rendered. In some embodiments (not shown), the facility orders the rows of the table in a way that maximizes compression effectiveness.

In some embodiments (not shown), the facility either includes in the encoded video sequence a more immediately-actionable control artifact for the encoded video sequence that maps directly from any time index to a formula for determining the appropriate frame or sequence of frames to render. In some embodiments, rather than including this control artifact in the encoded video sequence, the facility uses the branching table to construct it in the playing device.

While FIG. 6 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

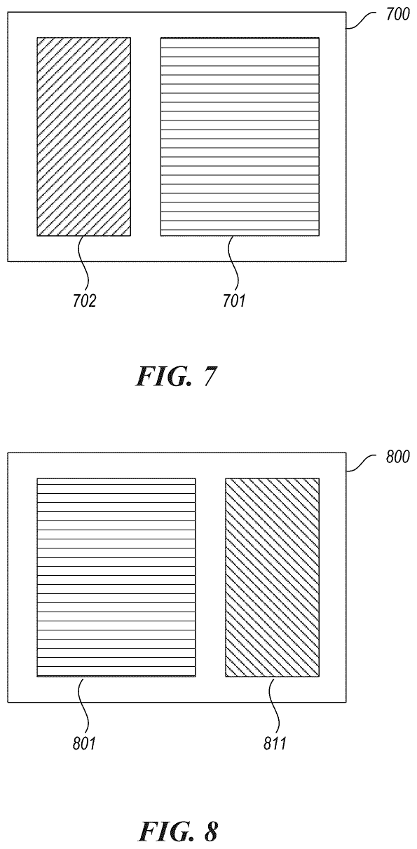

FIGS. 7 and 8 are media rendering diagrams showing examples of opportunities for compression efficacy taken advantage of by the facility in some embodiments. FIGS. 7 and 8 show a similar example, in which a branching video sequence contains two segments each relating to traversal of two parallel paths through a physical environment. FIG. 7 shows a frame in the “left-path” segment, while FIG. 8 shows a corresponding frame in the “right-path” segment. One of the two segments shown in FIGS. 7 and 8 is rendered based upon a branch that tests whether the user of the playing device has provided input constituting a “follow left path” game play action, or input constituting a “follow right path” game play option. In a frame 700 of the first segment, the user gave input to follow a left-hand path, and the frame is made up of visual content 701 representing a central area of the physical environment and visual content 702 showing a left-hand portion of the physical environment that is visible when following the left-hand path. In contrast, FIG. 8 shows a corresponding frame 800, wherein video content 801 showing a central portion of the physical environment corresponding to visual content 701 shown in FIG. 7 is displayed, this time on the left side of the frame together with visual content 811 portraying a right-hand portion of the physical environment that is visible when following the right-hand path. In some embodiments, when compressing these segments, the facility achieves a level of compression at which the total size of the compressed blob is at least as small as the size of the data content of visual sections 702 and 811, added to the size of a single copy of visual portion 701.

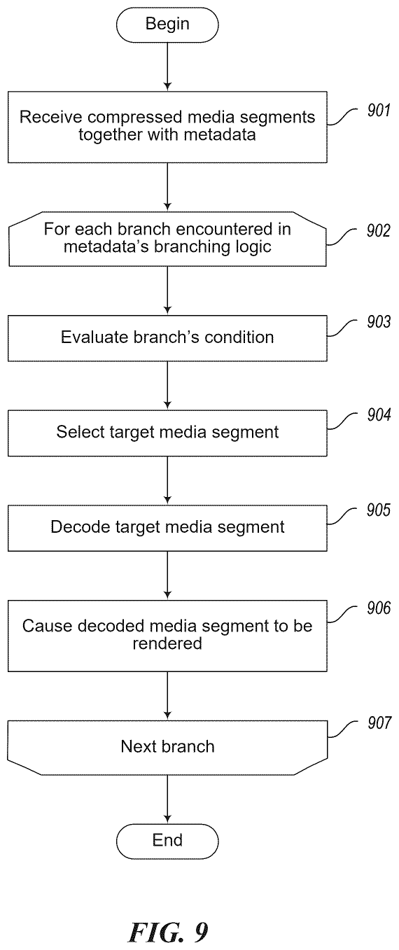

FIG. 9 is a flow diagram showing a process performed by the facility in some embodiments to decode a branching video sequence. In act 901, the facility receives the branching video sequence, made up of compressed media segments and metadata providing their branching logic. In acts 902-907 the facility loops through each branch encountered in the metadata's branching logic. In act 903, the branch identifies a plurality of target media segments, and the facility evaluates the condition determined for the branch. In act 904, based upon the evaluation of act 903, the facility selects the target media segment compressed within the branching video sequence. In act 905, the facility decompresses or otherwise decodes the target media segment selected in act 904. In act 906, the facility causes the media segment decoded in act 905 to be rendered, such as on output devices connected to the playing device. In some embodiments, the facility begins an iteration of this loop at a time before rendering of the current segment is completed, to provide time to perform acts 903-905 at least partially before the rendering of this media segment begins in act 906. In act 907, if one or more additional branches remain in the metadata's branching logic, then the facility continues in act 902 to process the next encountered branch, else this process concludes.

In some embodiments, the facility streams multiple video streams concurrently, each of the streams representing a possible future outcome associated with one of several possible user input events. The playing device selects one of these streams to render at different moments in time based upon the occurrence of user input events.

In some embodiments, the facility encodes video at a higher rate than it will be rendered (the target fps), with each intermediary frame in the stream associated with a probable user input action. When the video is decoded into the cache, each frame is sorted into the appropriate slots corresponding to probable future user interactions. Because the video is in many cases a continuous scene, and the incremental differences between possible user interactions is very small, all of the subsequent extra frames will often tend to look very similar to one another, and therefore compress efficiently.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for constructing a branching media sequence, comprising:
accessing a specification of a branching media sequence, the specification identifying a plurality of media segments, the specification further specifying, for each of at least a portion of the plurality of media segments, a branch to be performed at a conclusion of the media segment's rendering, the branch identifying a plurality of target media segments among the plurality of media segments and specifying for each target media segment a test result that is to cause the rendering of the target segment directly following the rendering of the media segment;
accessing the identified plurality of media segments;
encoding the identified plurality of media segments,
constructing the branching media sequence containing the encoded plurality of media segments, together with branching logic representing branches specified by the accessed specification;
constructing the accessed specification; and
contemporaneously with constructing the accessed specification, automatically generating at least one of the identified media segments.

2. The method of claim 1 wherein media segments among the plurality of media segments specified by the accessed specification comprise one or more of:
a single ordered chain of two-dimensional video frames;
a binocular pair of ordered chains of two-dimensional video frames;
a single ordered chain of three-dimensional video frames; and
one or more audio tracks.

3. The method of claim 1, further comprising:
presenting a user interface usable to construct the accessed specification;
receiving input interacting with the presented user interface; and
constructing the accessed specification responsive to the received input.

4. The method of claim 1, further comprising:
automatically constructing the accessed specification.

5. (canceled)

6. The method of claim 1 wherein the automatic generation is performed by a game engine.

7. The method of claim 1 wherein the encoding comprises collectively compressing the media segments of the plurality of media segments in a manner that reduces the effect on the size of the encoded media segments of redundancies between the media segments of the plurality of media segments.

8. The method of claim 1, further comprising:
transmitting the constructed branching media sequence to a playing device for rendering.

9. The method of claim 8, further comprising:
receiving from the playing device an indication of one of the identified media segments that was rendered based upon a branch for which it was a target media segment; and
in response to receiving, repeating the accessing, accessing, encoding, constructing, and transmitting.

10-16. (canceled)

17. One or more memories collectively having contents configured to cause a computing system to perform a method, the method comprising:
accessing a branching media sequence comprising a plurality of media segments and branching logic for routing among the media segments;
rendering a first media segment of the plurality of media segments;
selecting a branch among the branching logic associated with the first media segment;
evaluating a condition specified for the selected branch to obtain an evaluation result;
identifying a second media segment of the plurality of media segments identified by the selected branch for the obtained evaluation result;
rendering the identified second media segment directly after the first media segment; and
receiving the accessed branching media sequence from a server by which it was constructed.

18. (canceled)

19. The one or more memories of claim 17, the method further comprising:
transmitting to the server an indication that the second media segment was identified for rendering.

20. The one or more memories of claim 17, the method further comprising:
before rendering the first media segment, decoding the first media segment from the accessed branching media sequence; and
in response to identifying the second media segment, decoding the media segment from the accessed branching media sequence,
wherein the selected branch identifies a third media segment of the plurality of media segments for an evaluation result other than the obtained evaluation result, and wherein the third media segment is not decoded from the accessed branching media sequence.

21. The one or more memories of claim 17 wherein the conditions specified for the selected branch is based on one or more of:
a persistent attribute of the computing system,
a volatile state of the computing system, and/or
input received by the computing system.

22. The one or more memories of claim 17, the method further comprising:
selecting a second branch among the branching logic associated with the second media segment;
evaluating a condition specified for the selected second branch to obtain a second evaluation result;
identifying a third media segment of the plurality of media segments identified by the selected second branch for the obtained second evaluation result; and
rendering the identified third media segment directly after the second media segment.

23. One or more memories collectively having contents configured to cause a computing system to perform a method for constructing a branching media sequence, the method comprising:
accessing a specification of a branching media sequence, the specification identifying a plurality of media segments, the specification further specifying, for each of at least a portion of the plurality of media segments, a branch to be performed at a conclusion of the media segment's rendering, the branch identifying a plurality of target media segments among the plurality of media segments and specifying for each target media segment a test result that is to cause the rendering of the target segment directly following the rendering of the media segment;
accessing the identified plurality of media segments;
encoding the identified plurality of media segments;
constructing the branching media sequence containing the encoded plurality of media segments, together with branching logic representing branches specified by the accessed specification,
wherein the encoding comprises collectively compressing the media segments of the plurality of media segments in a manner that reduces the effect on the size of the encoded media segments of redundancies between the media segments of the plurality of media segments.

24. The one or more memories of claim 23, the method further comprising:
constructing the accessed specification; and
contemporaneously with constructing the accessed specification, automatically generating at least one of the identified media segments.

25. The one or more memories of claim 23 wherein the encoding comprises collectively compressing the media segments of the plurality of media segments in a manner that reduces the effect on the size of the encoded media segments of redundancies between the media segments of the plurality of media segments.

26. A method in a computing system for constructing a branching media sequence, comprising:
accessing a branching media sequence comprising a plurality of media segments and branching logic for routing among the media segments;
rendering a first media segment of the plurality of media segments;
selecting a branch among the branching logic associated with the first media segment;
evaluating a condition specified for the selected branch to obtain an evaluation result;
identifying a second media segment of the plurality of media segments identified by the selected branch for the obtained evaluation result;
rendering the identified second media segment directly after the first media segment; and
transmitting to the server an indication that the second media segment was identified for rendering.

27. The method of claim 26, further comprising:
before rendering the first media segment, decoding the first media segment from the accessed branching media sequence; and
in response to identifying the second media segment, decoding the media segment from the accessed branching media sequence,
wherein the selected branch identifies a third media segment of the plurality of media segments for an evaluation result other than the obtained evaluation result,
and wherein the third media segment is not decoded from the accessed branching media sequence.

28. The method of claim 26 wherein the conditions specified for the selected branch is based on one or more of:
a persistent attribute of the computing system,
a volatile state of the computing system, and/or
input received by the computing system.

29. The method of claim 26, further comprising:
selecting a second branch among the branching logic associated with the second media segment;
evaluating a condition specified for the selected second branch to obtain a second evaluation result;
identifying a third media segment of the plurality of media segments identified by the selected second branch for the obtained second evaluation result; and
rendering the identified third media segment directly after the second media segment.
